(19) United States
(12) Patent Application Publication
(10) Pub. No.: US 2022/0037754 A1
(43) Pub. Date: Feb. 3, 2022

(54) FILTER INCLUDING A FOLDED STRUCTURE RESONATOR FILTER

(71) Applicant: Telefonaktiebolaget LM Ericsson (publ), Stockholm (SE)

(72) Inventors: Chunyun JIAN, Ottawa (CA); Mi ZHOU, Nepean (CA)

(21) Appl. No.: 17/299,169

(22) PCT Filed: Dec. 6, 2018
(86) PCT No.: PCT/IB2018/059732

§ 371 Date: Jun. 2, 2021

(51) Int. Cl. H01P 1/20; H01P 3/08

(52) U.S. Cl. CPC H01P 1/20; H01P 3/08

(57) ABSTRACT

A radio frequency filter is disclosed. According to one aspect, the filter includes N stacked planar dielectric layers, N being an integer greater than 1. The filter also includes a first pair of coupled stripline resonators lying in a plane between 5 a first pair of planar dielectric layers. The filter also includes an outermost ground plane on either side of the stack of N stacked planar dielectric layers.

### TECHNICAL FIELD

Wireless communication and in particular, millimeter wave filters including folded structure resonator filters.

### BACKGROUND

Active Antenna Systems (AAS) are used in wireless communications and include arrays of antenna elements, such as, for example, an 8×16 or 16×16 arrays, which may be comprised of 4×4 array units. The dimensions of an antenna array depend mainly on the radio frequency (RF) of operation of the antenna. For example, the dimension of a 4×4 array at 28 Giga Hertz (GHz) is about 5×5 square millimeters. Usually, one antenna element can have two polarized antennas which may be orthogonally polarized. Each polarized antenna in the array will have its own filter. For an antenna with a transverse set of (x-y) dimensions, such filters should not have cross sectional (x-y) dimensions that are larger than the x-y size of the antenna.

Both printed circuit boards (PCB) and low temperature co-fired ceramics (LTCC) may be used to construct such filters. Their design may be based on transmission line theory. Typical designs include end-coupled half wavelength resonator filter designs, parallel-coupled half wavelength resonator filter designs and interdigital quarter wavelength resonator filter designs. These traditional filter designs all have x-y dimensions that are much larger than the antenna dimensions because the filter elements are in the same layer and some of them use the larger half-wavelength resonators.

To reduce the x-y dimensions, the resonators may be designed as stacked stripline resonators 2 separated by a ground plane 4. Such a structure is shown in FIG. 1. As shown in FIG. 1, a stack of dielectrics separating ground planes 4 and half wavelength stripline resonators 2 is configured such that an end of each stripline resonator 2 partially overlaps a window 6 in a ground plane to capacitively couple a stripline resonator 2A on one side of the ground plane 4 to a stripline resonator 2B on the other side of the ground plane 4. These windows 6 are alternately located at different ends of the ground planes 4 to form a set of series-connected resonators. Because the stripline resonators are stacked, the x-y dimensions of the resonator are smaller than the traditional designs discussed above. However, the filter of FIG. 1 is still large in dimension relative to antenna element dimensions because the filter uses a plurality of the relatively large half wavelength stripline resonators.

### SUMMARY

Some embodiments advantageously provide millimeter wave filters including folded structure resonator filters. According to one aspect, a filter design using inductively coupled quarter wavelength stripline resonators is provided. In some embodiments, the stripline resonators are stacked and inductively coupled through windows formed in ground planes that separate the stripline resonators. According to this aspect, because of the use of relatively smaller quarter wavelength stripline resonators, the filter has x-y dimensions that are commensurate with x-y dimensions of the antenna elements.

According to another aspect, a folded structure resonator filter design is provided. In some embodiments, an in-plane pair of inductively coupled stripline resonators are situated between ground planes. For a design with two dielectric layers, the ground planes encompass the dielectric layers and provide input output ports in one of the ground planes. For a design with more than two dielectric layers, pairs of in-plane stripline resonators lying in different planes are inductively coupled by a window through a ground plane separating the pairs. This folded structure resonator filter design has not only small x-y dimensions commensurate with the x-y dimensions of an antenna element, but also has a low profile z dimension, orthogonal to the x-y dimensions.

According to one aspect, a millimeter wave filter is provided. The filter includes a plurality of stripline resonators, each stripline resonator lying in a plane in parallel with a first plane of a three-dimensional rectangular coordinate system, and inductively coupled to another stripline resonator of the plurality of stripline resonators. The filter further includes a first plurality of ground planes oriented in parallel to the first plane, at least a first ground plane of the first plurality of ground planes being a first outermost ground plane and having a first window therein. The filter also includes a first input/output port having a conductor electrically connected to a first stripline resonator of the plurality of resonators, the conductor extending perpendicularly away from the first stripline resonator of the plurality of resonators toward the first window in the first outermost ground plane.

According to this aspect, in some embodiments, two of the plurality of stripline resonators lying in a same plane are separated by a first distance and are inductively coupled by a coupling stripline. In some embodiments, the filter further includes a second ground plane of a second plurality of ground planes arranged perpendicular to the first plane of the first plurality of ground planes and which terminates the two stripline resonators of the plurality of stripline resonators, and wherein a second distance of the coupling stripline from the second ground plane of the second plurality of ground planes is selected to achieve a desired inductive coupling of the two stripline resonators of the plurality of stripline resonators.

In some embodiments, the filter further includes a plurality of metallized vias extending between the two stripline resonators from the first outermost ground plane of the first plurality of ground planes to a second outermost ground plane of the first plurality of ground planes, the first and second outermost ground planes of the first plurality of ground planes being parallel to the first plane and encompassing the plurality of stripline resonators. In some embodiments, the filter further includes N dielectric layers, N being an integer greater than 2. In some embodiments, a first outermost layer of the N dielectric layers has adjacent thereto the first outermost ground plane of the first plurality of ground planes. In some embodiments, N−2 intermediate dielectric layers of the N dielectric layers are configured such that each intermediate dielectric layer separates an intermediate ground plane of the first plurality of ground planes from at least one stripline resonator. In some embodiments, the Nth dielectric layer is a second outermost layer of the N dielectric layers having an adjacent second outermost ground plane of the first plurality of ground planes, the first and second outermost ground planes of the first plurality of ground planes encompassing the N−2 intermediate dielectric layers and the intermediate ground planes of the first plurality of ground planes. In some embodiments, two intermediate dielectric layers of the N−2 intermediate dielectric layers encompass a first pair of the plurality of stripline resonators, the first pair lying in a same plane, separated from each other by a first distance and inductively coupled by a coupling stripline.

In some embodiments, the filter includes, lying in the same plane as the first pair of stripline resonators, a third stripline resonator separated from one of the first pair of stripline resonators by a gap. In some embodiments, the filter includes a plurality of metallized vias extending from the first outermost ground plane of the first plurality of ground planes to the second outermost ground plane of the first plurality of ground planes through the gap. In some embodiments, the filter includes a stripline located between the gap and a ground plane of the first plurality of ground planes, the stripline being wider than the gap and being configured to provide capacitive coupling between the third stripline resonator and the one of the first pair of stripline resonators. In some embodiments, the filter includes two parallel stripline resonators lying in different planes and separated by two intermediate dielectric layers having a ground plane of the first plurality of ground planes interposed the ground plane of the first plurality of ground planes having a second window configured to inductively couple the two parallel stripline resonators. In some embodiments, the filter includes, passing through the second window, an elongated conductor perpendicular to the two parallel stripline resonators, and terminating within the dielectric so that a first dielectric gap exists between a first terminal end of the elongated conductor and a first of the two parallel stripline resonators and so that a second dielectric gap exists between a second terminal end of the elongated conductor and the second of the two parallel stripline resonators to provide capacitive coupling between the two parallel stripline resonators.

In some embodiments, two of the plurality of stripline resonators are each on opposite sides of a ground plane having a window to inductively couple the two stripline resonators. In some embodiments, the conductor of the first input/output port is a circular cylinder that extends through the first window and is circumferentially encompassed around a portion thereof by a cylindrical outer conductor connected to the first outermost ground plane of the first plurality of ground planes to enable connection of the conductor to other device such as a coaxial cable. In some embodiments, the inductively coupled stripline resonators have an equivalent circuit model consisting of two electrically parallel resonant circuits that are electrically connected together through an inductor.

According to another aspect, a radio frequency filter is provided. The filter includes N stacked planar dielectric layers, N being an integer greater than 1, a first pair of coupled stripline resonators lying in a plane between a first pair of planar dielectric layers, and an outermost ground plane on either side of the stack of N stacked planar dielectric layers.

According to this aspect, in some embodiments, the first pair of coupled stripline resonators are inductively coupled via a stripline conductor. In some embodiments, the filter includes a third stripline resonator lying in the plane and being capacitively coupled to one of the inductively coupled stripline resonators of the first pair. In some embodiments, the filter further includes M adjacent stripline resonators lying in the same plane and being alternately capacitively and inductively coupled. In some embodiments, the first pair of coupled stripline resonators are capacitively coupled by a gap between the stripline conductors of the first pair and a metal plate embedded in a dielectric layer in proximity to the gap. In some embodiments, N is at least 4 and wherein lying between a second pair of planar dielectrics at a center of the stack, is a ground plane with at least one window configured to inductively couple one of the stripline resonators of the first pair of inductively coupled stripline resonators lying in a plane on one side of the ground plane to a first stripline resonator of a second pair of inductively coupled stripline resonators lying in a plane on an opposite side of the ground plane. In some embodiments, the ground plane has a second window through which a metal via passes to capacitively couple the other one of the stripline resonators of the first pair of inductively coupled stripline resonators, to a second stripline resonator of the second pair of inductively coupled stripline resonators.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a stacked filter structure;

FIG. 2 is a circuit schematic of a multi-pole resonator filter;

FIG. 3 is a drawing of an N-pole stacked filter with inductive coupling between resonators separated by a ground plane;

FIG. 4 is a drawing of a two pole filter with inductive coupling;

FIG. 5 is a side view of the two-pole filter of FIG. 4;

FIG. 6 is a circuit schematic of the two-pole filter of FIG. 4;

FIG. 7 is drawing of a two pole filter with inductive coupling by a circular window;

FIG. 8 is a graph of S parameters for a small coupling window;

FIG. 9 is a graph of S parameters for a large coupling window;

FIG. 10 is a graphical comparison of inductance for circular and rectangular windows;

FIG. 11 is a drawing of a three-pole stacked filter structure;

FIG. 12 is a graph of S parameters for the filter of FIG. 11;

FIG. 13 is a drawing of a four-pole stacked filter structure;

FIG. 14 is a graph of S parameters for the filter of FIG. 13;

FIG. 15 is top view of a folded structure filter;

FIG. 16 is a side view of the filter of FIG. 15;

FIG. 17 is a circuit schematic of the filter of FIG. 15;

FIG. 18 is a block diagram of the filter of FIG. 15;

FIG. 19 is a graph of S parameters for a small distance d of the coupling stripline shown in FIG. 15;

FIG. 20 is a graph of S parameters for a larger distance d of the coupling stripline shown in FIG. 15;

FIG. 21 is a graph of the inductance of stripline coupling as a function of distance d of the coupling stripline shown in FIG. 15;

FIG. 22 is a block diagram of a filter design

FIG. 23 is a side view of the filter design of FIG. 22;

FIG. 24 is a block diagram of another filter design;

FIG. 25 is a side view of the filter design of FIG. 24;

FIG. 26 is a block diagram of yet another filter design

FIG. 27 is a side view of the filter design of FIG. 26;

FIG. 28 is a top view of an embodiment of a folded structure filter;

FIG. 29 is a side view of the filter of FIG. 28;

FIG. 30 is a graph of S parameters of the filter of FIG. 28;

FIG. 31 is a first configuration of a first folded structure filter;

FIG. 32 is a second configuration of the first folded structure filter;

FIG. 33 is a first configuration of a second folded structure filter;

FIG. 34 is a second configuration of the second folded structure filter; and

FIG. 35 is a configuration of a third folded structure filter.

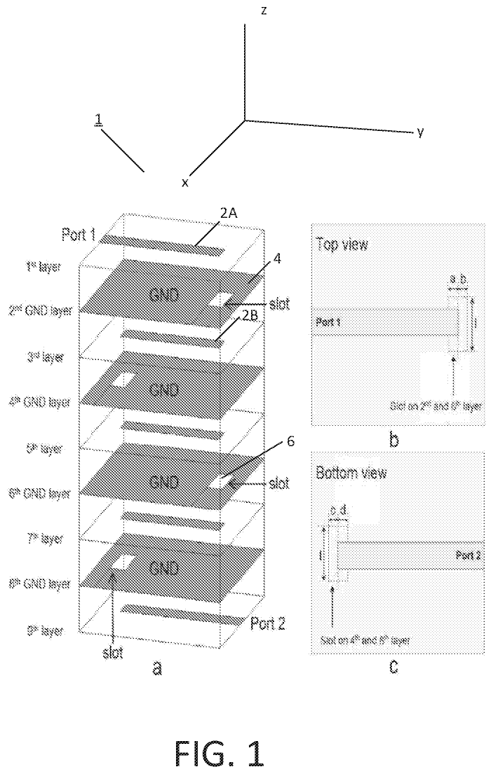

### DETAILED DESCRIPTION

Before describing in detail exemplary embodiments, it is noted that the embodiments reside primarily in millimeter wave filters including folded structure resonator filters. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

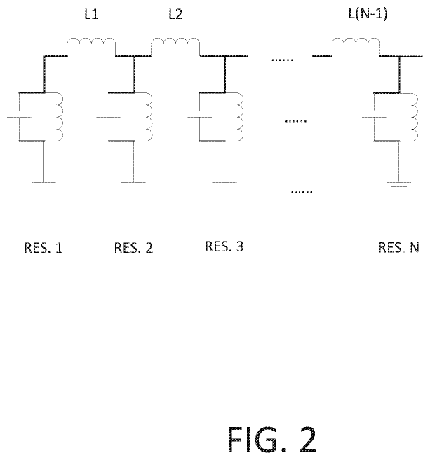

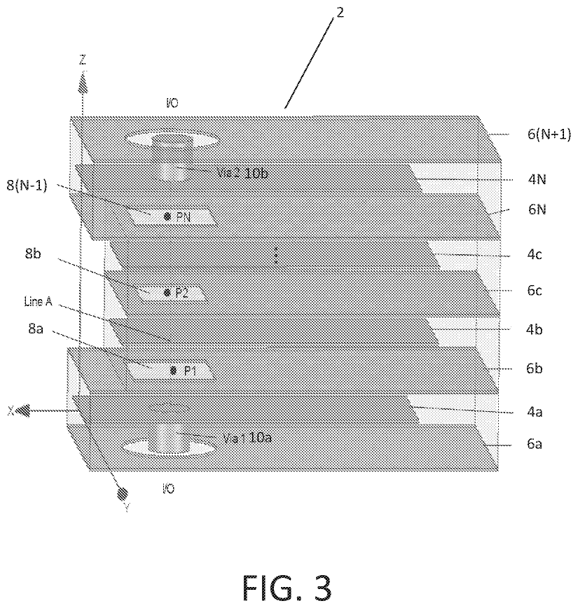

In some embodiments, millimeter wave filters including folded structure resonator filters are provided. FIG. 2 shows an N-pole resonator filter design that uses inductive coupling between resonators. This N-pole resonator circuit may be implemented using embodiments described below. Design arrangements for the inductive coupling L between the resonators are presented herein. FIG. 3 shows a 3-dimensional view of one embodiment of a filter 2 with inductive coupling L of stripline resonators 4a, 4b, 4c . . . 4N separated by ground planes 6a, 6b, 6c, . . . 6(N+1). FIG. 3 is a physical implementation of the circuit model of FIG. 2. As shown in FIG. 3, the stripline resonators 4a, 4b, 4c . . . 4N each have a circuit model consisting of the parallel combination of an inductor and a capacitor. The window 8a, 8b . . . 8(N−1) in each ground plane has a circuit model being an inductor L between the parallel combinations of an inductor and a capacitor. Via 10a is a signal connection between the resonator 4a and an input/output (I/O) port and via 10b is another signal connection between the resonator 4N and another I/O port. Note that stripline resonators 4a, 4b . . . 4N may be referred to herein collectively as stripline resonators 4. The ground planes 6a, 6b . . . 6(N+1) may be referred to herein collectively as ground planes 6. The inductive windows 8a, 8b . . . 8(N−1) may be referred to herein collectively as windows 8. Line A shows the symmetry of alignment of via 1 10a and via 2 10b. Note that the inductive windows 8 can be any shape such as rectangular, triangular, circular, etc. The points, P1, P2 . . . PN, are located about the center of the windows 8 such that Line A passes through or near to the points, P1, P2 . . . PN. Note also, the same dielectric material may be used for each layer, or in some embodiments, different dielectric materials may be used for different layers.

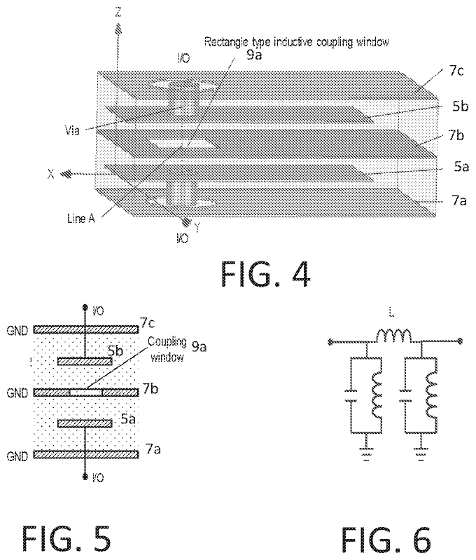

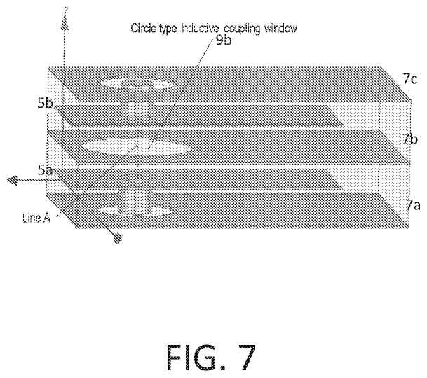

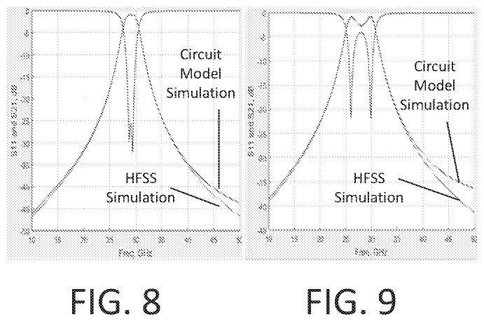

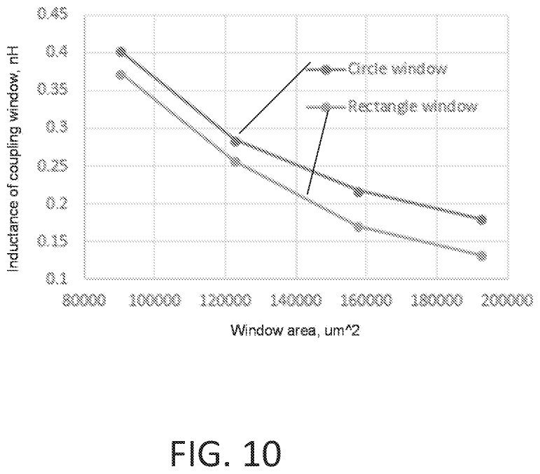

To demonstrate the coupling window providing inductive coupling, two simple cases of 2-pole resonator filters are shown in FIGS. 4 and 7. A side view of these filters is shown in FIG. 5 where it can be seen that a center ground plane 7b has a coupling window 9a to inductively couple the bottom and top stripline resonators 5a and 5b and that I/O ports pass through ground planes 7a and 7c. Ground planes 7a, 7b and 7c may be referred to collectively as ground planes 7. Stripline resonators 5a and 5b may be referred to collectively as stripline resonators 5. The two pole resonator equivalent circuit for these filters is shown in FIG. 6. In FIGS. 4 and 7, only the coupling window shapes are different and all other parameters are the same. In FIG. 4, the window 9a is rectangular, and in FIG. 7, the window 9b is circular. S parameters (as described below) of the two embodiments can be simulated using a commercially available simulation software program such as the High Frequency Structure Simulator (HFSS) 3D-EM tool and then the S parameters are fitted with the 2-pole circuit model. The S parameter S11 is a measure of energy reflected at an input port of the filter and the S parameter S21 is a measure of energy transmitted through the filter. These S parameters versus frequency are shown in FIGS. 8 and 9 for the circuits of FIGS. 4 (small (rectangular) coupling window) and 7 (large (circular) coupling window), showing good agreement between the HFSS result and the circuit model result. FIG. 10 is a graph showing the inductance achieved by the rectangular and circular windows as a function of window size. As shown in FIG. 10, the circular window provides greater inductance than the rectangular window for a given area. Note that the coupling window provides inductive coupling as a lumped inductor between two resonators. This enables greater ease in filter synthesis with only a few iterations of tuning to complete a filter design.

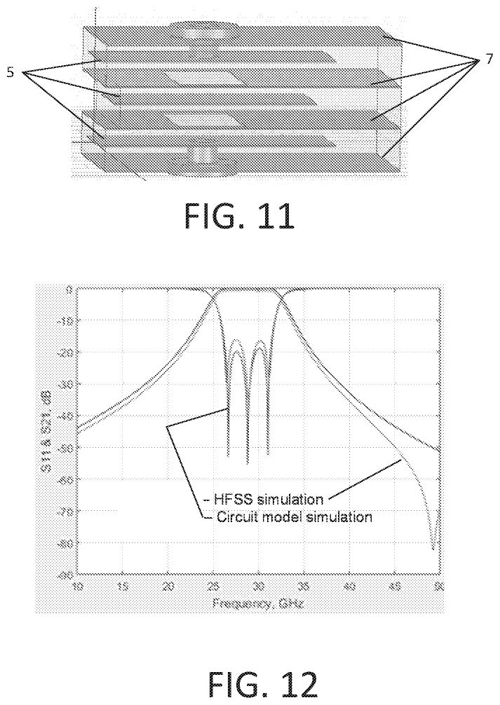

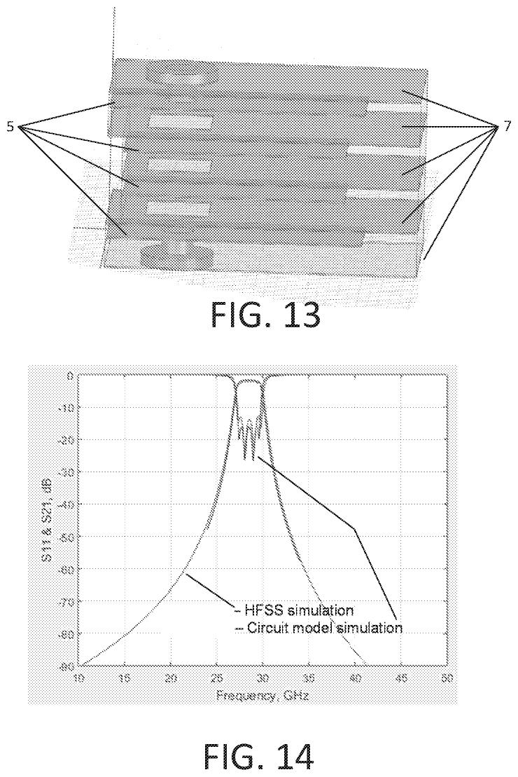

FIG. 11 is a three pole filter having inductively coupled quarter wavelength stripline resonators 5 between ground planes 7. The number of poles of the filter is also the number of stripline resonators 5. FIG. 12 is a graph of S parameters for the three pole filter of FIG. 11 generated by the HFSS simulation tool and by circuit model simulation. The three sharp negative peaks in the parameter S21 arise from the poles of the filter. FIG. 13 is a four pole filter having inductively coupled quarter wavelength stripline resonators 5 between ground planes 7. FIG. 14 is a graph of S parameters for the four pole filter of FIG. 13 generated by the HFSS simulation tool and by circuit model simulation. Once again, the negative peaks in the parameter S21 correspond to the poles of the filter.

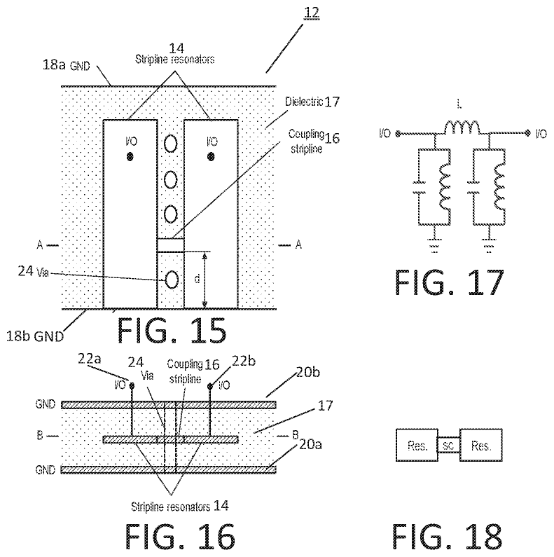

FIG. 15 is a top view of an embodiment referred to as a folded structure resonator filter 12 and FIG. 16 is a side view of the folded structure resonator filter 12 of FIG. 15. The filter includes in-plane inductively coupled stripline resonators 14, which result in a compact filter that is of reduced dimension in both the x-y dimensions and the z-dimension. The stripline resonators 14 are inductively coupled by a coupling stripline 16 lying in the plane having the stripline resonators 14. The stripline resonators 14 and coupling stripline 16 may be embedded in dielectric material 17. In some embodiments, the filter may be manufactured by printing the conductors 14 and 16 on a surface of a first dielectric layer and enclosing the conductors 14 and 16 by adding another dielectric over the first dielectric layer.

At one end of the stripline resonators 14, and positioned away from the end of the stripline resonators 14 is a first ground plane 18a. At the other end of the stripline resonators 14 is a second ground plane 18b which conductively terminates the stripline resonators 14. Thus, the ground planes 18a and 18b enclose the sides of the filter 12. Ground planes 20a and 20b cover the top and bottom of the dielectric material 17 and thereby enclose the stripline resonators 14 and coupling stripline 16, except for two openings in the ground plane 20a, which openings receive input/output (I/O) conductors 22a and 22b. Grounded metallized vias 24 extend from the ground plane 20a to the ground plane 20b and serve to isolate the stripline resonators 14.

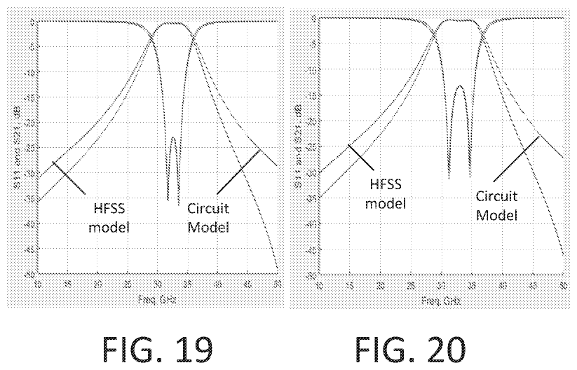

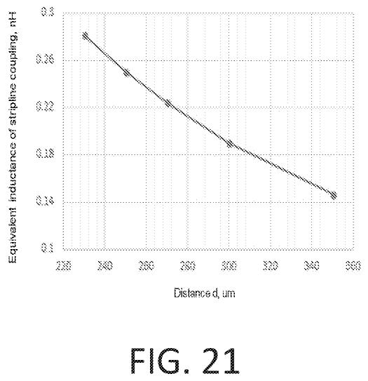

FIG. 17 shows an equivalent circuit model of the filter 12 shown in FIGS. 15 and 16. FIG. 18 shows a schematic of the filter structure of FIGS. 15 and 16, where “Res.” denotes a stripline resonator 14 and “SC” denotes coupling stripline 16. FIG. 19 shows the HFSS model S parameter results and circuit model S parameter results for small value of the distance d, where d is a distance between the ground plane 18b and the coupling stripline 16, and FIG. 20 shows the results for a larger value of d. Note the good match between the HFSS and circuit model results around the passband. FIG. 21 is a graph showing the relation between the equivalent inductance stripline coupling in nano-Henrys versus distance d, showing that inductance may be controlled by positioning of the coupling stripline 16.

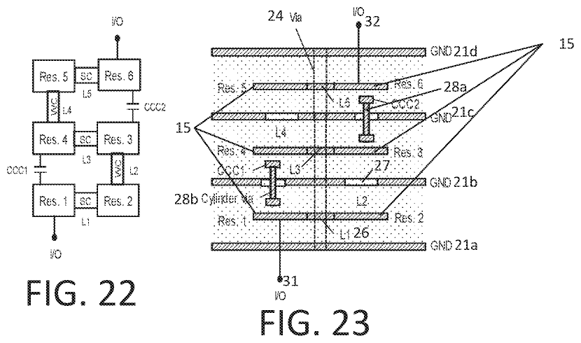

Embodiments of multi-pole filters may be based on the N-pole circuit model of FIG. 2, where N is greater than 2. For example, FIGS. 22 is a schematic diagram and 23 is a side view of a 6-pole folded structure filter having six stripline resonators 15 coupled either inductively or capacitively. In FIG. 22, “WC” means a window coupling between two resonators. For example, resonator 1 and resonator 2 are in-plane stripline resonators that are inductively coupled by a coupling stripline L1 26. Resonator 2 and resonator 3 are in different planes and are inductively coupled by window 27 giving rise to inductance L2. In contrast to the inductive coupling by a window in the ground plane, such as by the window 27 giving rise to the inductance L2, a capacitive coupling between resonators 3 and 6 is achieved by a cylindrical via 28a capped by a patch on each end of the via 28a the via 28a terminating at each end within the dielectric above resonator 3 and below resonator 6. Here, CCC stands for capacitive cross coupling. Similarly, resonator 4 is inductively coupled to resonator 5 through a window giving rise to inductance L4. Resonator 3 is also inductively coupled to resonator 4 by way of a coupling stripline giving rise to inductance L3. Resonator 1 is capacitively coupled to resonator 4 by via 28b. Resonator 6 is inductively coupled to resonator 5 by way of a coupling stripline giving rise to inductance L5. A lower I/O connection 31 is coupled out of the filter structure by a cylindrical via extending from resonator 1. An upper I/O connection 32 is coupled out of the filter structure by a cylindrical via extending from resonator 6. Grounded metallized vias 24 extend from the lower most ground plane 21a to the upper most ground plane 21d. Ground planes 21a, 21b, 21c and 21d are referred to collectively herein as ground planes 21.

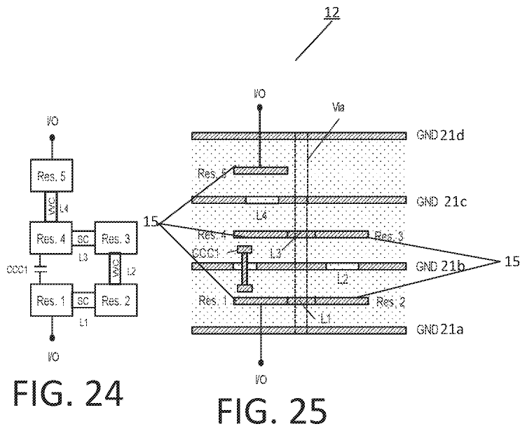

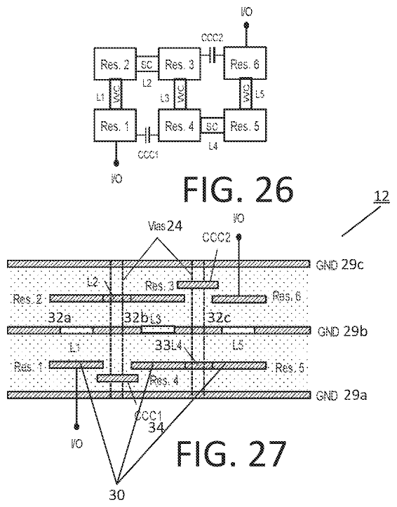

Similarly, other folded structure filters 12, such as the filters 12 shown in FIGS. 24 and 25 and in FIGS. 26 and 27, may be constructed. Note that the structure of FIG. 24 is like the structure of FIG. 22, except for the absence of a resonator 6 and the repositioning of the upper I/O connection. FIGS. 26 and 27 show a filter with three stripline resonators in a plane. For example, resonators 30, are in the same plane. Resonator 1 is capacitively coupled to resonator 4 via a capacitive coupler 34 which is a metal patch between the plane of resonators 1 and 4 and the lower most ground plane 29a. Resonator 4 is inductively coupled to resonator 5 by a coupling stripline 33 giving rise to an inductance L4. The center ground plane 29b has three windows to inductively couple resonators in the lower layer to resonators in the upper layer. Thus, a window 32a giving rise to inductance L1 inductively couples resonator 1 and resonator 2. The window 32b giving rise to inductance L3 inductively couples resonator 3 and resonator 4. The window 32c giving rise to inductance L5 inductively couples resonator 5 and resonator 6. Resonator 2 is inductively coupled to resonator 3 by a coupling strip giving rise to inductance L2. Resonator 3 is capacitively coupled to resonator 6 via CCC2. Two rows of metallized vias 24 extend from the lowermost ground plane 29a to the uppermost ground plane 29c. Ground planes 29a, 29b and 29c may be referred to collectively as ground planes 29.

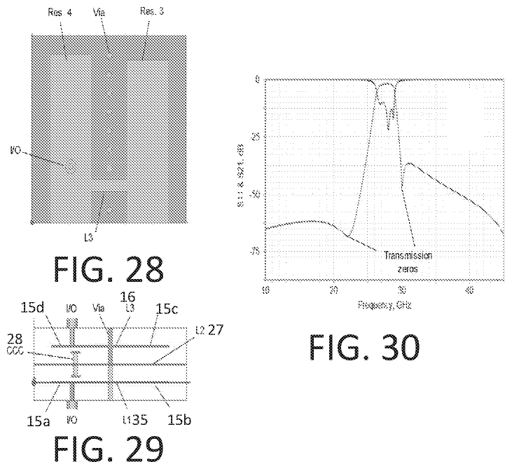

FIGS. 28 and 29 show a four-pole filter design example with stripline resonators 15. In FIGS. 28 and 29, a resonator 15a is inductively coupled to a resonator 15b lying in the same plane by a coupling stripline 35 giving rise to inductance L1. Resonator 15d is inductively coupled to resonator 15c lying in the same plane by a coupling stripline 16 giving rise to inductance L3. Resonator 15b is inductively coupled to resonator 15c via a window 27 giving rise to inductance L2. In contrast, resonator 15a is capacitively coupled to resonator 15d by a metalized via 28 giving rise to a capacitive cross coupling CCC. This results in two transmission zeros in the S21 parameter response of the filter, as shown in FIG. 30.

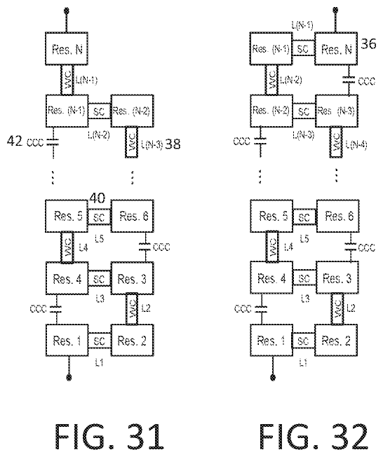

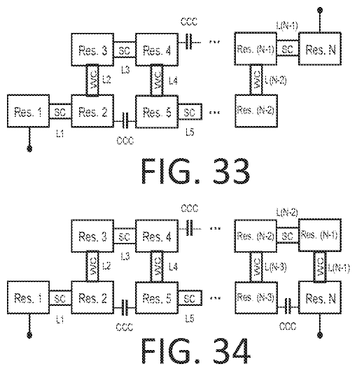

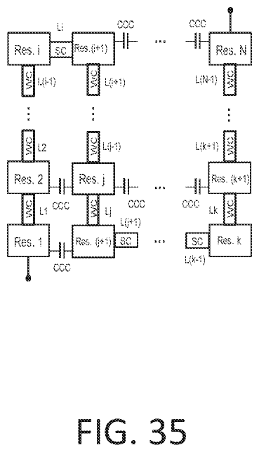

FIGS. 31 and 32 show two schematics of N-pole folded structure filter models that can be implemented with in-plane and out-of-plane stripline resonators 36, inductive window couplings (WC) 38, coupling striplines (SC) 40, and optionally, capacitive cross coupling (CCC) 42. A difference between the schematics shown in FIGS. 31 and 32 is the location of the Nth resonator and consequent position of the I/O connection at the top of the filter structure. FIGS. 33, 34 and 35 show two more examples of N-pole folded structure filter models that may be implemented as described above. In FIG. 35, for example, a plurality of resonators are cascaded through a series of WC couplings to form a group, where each group is coupled to its adjacent group through a SC coupling at its start or ending resonator. A common feature among the structures of FIGS. 32-35 is that the SC (coupling stripline) is never used for more than two consecutive resonators because such may deviate from an inductive coupling effect.

Thus, according to one aspect, filter 12 (see e.g., FIG. 15) is provided. The filter 12 includes a plurality of stripline resonators 14, each stripline resonator lying in a plane in parallel with a first plane of a three-dimensional rectangular coordinate system, and inductively coupled to another stripline resonator of the plurality of stripline resonators 14. The filter 12 further includes a first plurality of ground planes, 7, 20, 21, 29, oriented in parallel to the first plane, at least a first ground plane of the first plurality of ground planes, 7, 20, 21, 29, being a first outermost ground plane and having a first window therein. The filter 12 also includes a first input/output, 31, 32, port having a conductor electrically connected to a first stripline resonator of the plurality of resonators 14, the conductor extending perpendicularly away from the first stripline resonator of the plurality of resonators 14 toward the first window in the first outermost ground plane.

According to this aspect, in some embodiments, two of the plurality of stripline resonators 14 lying in a same plane are separated by a first distance and are inductively coupled by a coupling stripline 14. In some embodiments, the filter 12 further includes a second ground plane of a second plurality of ground planes 18 arranged perpendicular to the first plane of the first plurality of ground planes and which terminates the two stripline resonators 14 of the plurality of stripline resonators 14, and wherein a second distance of the coupling stripline from the second ground plane of the second plurality of ground planes 18 is selected to achieve a desired inductive coupling of the two stripline resonators of the plurality of stripline resonators 14. In some embodiments, the filter 12 further includes a plurality of metallized vias 24 extending between the two stripline resonators 14 from the first outermost ground plane of the first plurality of ground planes 7, 20, 21, 29 to a second outermost ground plane of the first plurality of ground planes 7, 20, 21, 29, the first and second outermost ground planes of the first plurality of ground planes 7, 20, 21, 29 being parallel to the first plane and encompassing the plurality of stripline resonators 14. In some embodiments, the filter further includes N dielectric layers, N being an integer greater than 2. In some embodiments, a first outermost layer of the N dielectric layers has adjacent thereto the first outermost ground plane of the first plurality of ground planes 20, 21, 29. In some embodiments, N−2 intermediate dielectric layers of the N dielectric layers are configured such that each intermediate dielectric layer separates an intermediate ground plane of the first plurality of ground planes 20, 21, 29 from at least one stripline resonator 12. In some embodiments, the Nth dielectric layer is a second outermost layer of the N dielectric layers having an adjacent second outermost ground plane of the first plurality of ground planes 20, 21, 29, the first and second outermost ground planes of the first plurality of ground planes 20, 21, 29 encompassing the N−2 intermediate dielectric layers and the intermediate ground planes of the first plurality of ground planes 20, 21, 29. In some embodiments, two intermediate dielectric layers of the N−2 intermediate dielectric layers encompass a first pair of the plurality of stripline resonators 14, the first pair lying in a same plane, separated from each other by a first distance and inductively coupled by a coupling stripline 14. In some embodiments, the filter 12 includes, lying in the same plane as the first pair of stripline resonators, a third stripline resonator separated from one of the first pair of stripline resonators 14 by a gap. In some embodiments, the filter includes a plurality of metallized vias 24 extending from the first outermost ground plane of the first plurality of ground planes 20, 21, 29 to the second outermost ground plane of the first plurality of ground planes 20, 21, 29 through the gap. In some embodiments, the filter 12 includes a stripline 34 located between the gap and a ground plane of the first plurality of ground planes 20, 21, 29, the stripline 34 being wider than the gap and being configured to provide capacitive coupling between the third stripline resonator and the one of the first pair of stripline resonators 14. In some embodiments, the filter 12 includes two parallel stripline resonators 14 lying in different planes and separated by two intermediate dielectric layers having a ground plane of the first plurality of ground planes 20, 21, 29 interposed the ground plane of the first plurality of ground planes 20, 21, 29 having a second window configured to inductively couple the two parallel stripline resonators 14. In some embodiments, the filter 12 includes, passing through the second window, an elongated conductor perpendicular to the two parallel stripline resonators 14, and terminating within the dielectric so that a first dielectric gap exists between a first terminal end of the elongated conductor and a first of the two parallel stripline resonators 14 and so that a second dielectric gap exists between a second terminal end of the elongated conductor and the second of the two parallel stripline resonators 14 to provide capacitive coupling between the two parallel stripline resonators 14. In some embodiments, two of the plurality of stripline resonators 14 are each on opposite sides of a ground plane having a window to inductively couple the two stripline resonators 14. In some embodiments, the conductor of the first input/output port is a circular cylinder that extends through the first window and is circumferentially encompassed around a portion thereof by a cylindrical outer conductor connected to the first outermost ground plane of the first plurality of ground planes to enable connection of the conductor to other device such as a coaxial cable. In some embodiments, the inductively coupled stripline resonators 14 have an equivalent circuit model consisting of two electrically parallel resonant circuits that are electrically connected together through an inductor.

According to another aspect, a radio frequency filter 12 is provided. The filter includes N stacked planar dielectric layers, N being an integer greater than 1, a first pair of coupled stripline resonators 14 lying in a plane between a first pair of planar dielectric layers, and an outermost ground plane on either side of the stack of N stacked planar dielectric layers.

According to this aspect, in some embodiments, the first pair of coupled stripline resonators 14 are inductively coupled via a stripline conductor 14. In some embodiments, the filter includes a third stripline resonator lying in the plane and being capacitively coupled to one of the inductively coupled stripline resonators 14 of the first pair. In some embodiments, the filter further includes M adjacent stripline resonators 14 lying in the same plane and being alternately capacitively and inductively coupled. Note that M is not necessarily equal to N. In some embodiments, the first pair of coupled stripline resonators 14 are capacitively coupled by a gap between the stripline conductors of the first pair and a metal plate embedded in a dielectric layer in proximity to the gap. In some embodiments, N is at least 4 and wherein lying between a second pair of planar dielectrics at a center of the stack, is a ground plane 20, 29 with at least one window configured to inductively couple one of the stripline resonators of the first pair of inductively coupled stripline resonators 14 lying in a plane on one side of the ground plane to a first stripline resonator of a second pair of inductively coupled stripline resonators lying in a plane on an opposite side of the ground plane 20, 21, 29. In some embodiments, the ground plane has a second window through which a metal via passes to capacitively couple the other one of the stripline resonators 14 of the first pair of inductively coupled stripline resonators 14, to a second stripline resonator of the second pair of inductively coupled stripline resonators 14.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A filter comprising:
a plurality of stripline resonators, each stripline resonator lying in a plane in parallel with a first plane of a three-dimensional rectangular coordinate system, and inductively coupled to another stripline resonator of the plurality of stripline resonators;
a first plurality of ground planes oriented in parallel to the first plane, at least a first ground plane of the first plurality of ground planes being a first outermost ground plane and having a first window therein; and
a first input/output port having a conductor electrically connected to a first stripline resonator of the plurality of stripline resonators, the conductor extending perpendicularly away from the first stripline resonator of the plurality of resonators toward the first window in the first outermost ground plane.

2. The filter of claim 1, wherein two of the plurality of stripline resonators lying in a same plane are separated by a first distance and are inductively coupled by a coupling stripline.

3. The filter of claim 2, further comprising a second ground plane of a second plurality of ground planes arranged perpendicular to the first plane of the first plurality of ground planes and which terminates the two stripline resonators of the plurality of stripline resonators, and wherein a second distance of the coupling stripline from the second ground plane of the second plurality of ground planes is selected to achieve a desired inductive coupling of the two stripline resonators of the plurality of stripline resonators.

4. The filter of claim 2, further comprising a plurality of metallized vias extending between the two stripline resonators from the first outermost ground plane of the first plurality of ground planes to a second outermost ground plane of the first plurality of ground planes, the first and second outermost ground planes of the first plurality of ground planes being parallel to the first plane and encompassing the plurality of stripline resonators.

5. The filter of claim 1, further comprising N dielectric layers, N being an integer greater than 2, and wherein:
a first outermost layer of the N dielectric layers has adjacent thereto the first outermost ground plane of the first plurality of ground planes;
N−2 intermediate dielectric layers of the N dielectric layers are configured such that each intermediate dielectric layer separates an intermediate ground plane of the first plurality of ground planes from at least one stripline resonator; and
the Nth dielectric layer is a second outermost layer of the N dielectric layers having an adjacent second outermost ground plane of the first plurality of ground planes, the first and second outermost ground planes of the first plurality of ground planes encompassing the N−2 intermediate dielectric layers and the intermediate ground planes of the first plurality of ground planes.

6. The filter of claim 5, wherein two intermediate dielectric layers of the N−2 intermediate dielectric layers encompass a first pair of the plurality of stripline resonators, the first pair lying in a same plane, separated from each other by a first distance and inductively coupled by a coupling stripline.

7. The filter of claim 6, further comprising, lying in the same plane as the first pair of stripline resonators, a third stripline resonator separated from one of the first pair of stripline resonators by a gap.

8. The filter of claim 7, further comprising a plurality of metallized vias extending from the first outermost ground plane of the first plurality of ground planes to the second outermost ground plane of the first plurality of ground planes through the gap.

9. The filter of claim 7, further comprising a stripline located between the gap and a ground plane of the first plurality of ground planes, the stripline being wider than the gap and being configured to provide capacitive coupling between the third stripline resonator and the one of the first pair of stripline resonators.

10. The filter of claim 5, further comprising two parallel stripline resonators lying in different planes and separated by two intermediate dielectric layers having a ground plane of the first plurality of ground planes, the ground plane of the first plurality of ground planes having a second window configured to inductively couple the two parallel stripline resonators.

11. The filter of claim 10, further comprising, passing through the second window, an elongated conductor perpendicular to the two parallel stripline resonators, and terminating within the dielectric so that a first dielectric gap exists between a first terminal end of the elongated conductor and a first of the two parallel stripline resonators and so that a second dielectric gap exists between a second terminal end of the elongated conductor and the second of the two parallel stripline resonators to provide capacitive coupling between the two parallel stripline resonators.

12. The filter of claim 1, wherein two of the plurality of stripline resonators are each on opposite sides of a ground plane having a window to inductively couple the two stripline resonators.

13. The filter of claim 1, wherein the conductor of the first input/output port is a circular cylinder that extends through the first window and is circumferentially encompassed around a portion thereof by a cylindrical outer conductor connected to the first outermost ground plane of the first plurality of ground planes to enable connection of the conductor to other device such as a coaxial cable.

14. The filter of claim 2, wherein the inductively coupled stripline resonators have an equivalent circuit model consisting of two electrically parallel resonant circuits that are electrically connected together through an inductor.

15. A radio frequency, RF, filter, comprising:
N stacked planar dielectric layers, N being an integer greater than 1;
a first pair of coupled stripline resonators lying in a plane between a first pair of planar dielectric layers; and
an outermost ground plane on either side of the stack of N stacked planar dielectric layers.

16. The filter of claim 15, wherein the first pair of coupled stripline resonators are inductively coupled via a stripline conductor.

17. The filter of claim 15, further comprising a third stripline resonator lying in the plane and being capacitively coupled to one of the inductively coupled stripline resonators of the first pair.

18. The filter of claim 15, further comprising M adjacent stripline resonators lying in the same plane and being alternately capacitively and inductively coupled.

19. The filter of claim 15, wherein the first pair of coupled stripline resonators are capacitively coupled by a gap between the stripline conductors of the first pair and a metal plate embedded in a dielectric layer in proximity to the gap.

20. The filter of claim 15, wherein N is at least 4 and wherein lying between a second pair of planar dielectrics at a center of the stack, is a ground plane with at least one window configured to inductively couple one of the stripline resonators of the first pair of inductively coupled stripline resonators lying in a plane on one side of the ground plane to a first stripline resonator of a second pair of inductively coupled stripline resonators lying in a plane on an opposite side of the ground plane.

21. The filter of claim 20, wherein the ground plane. has a second window through which a metal via passes to capacitively couple the other one of the stripline resonators of the first pair of inductively coupled stripline resonators, to a second stripline resonator of the second pair of inductively coupled stripline resonators.
